(19) United States
(12) Patent Application Publication
(10) Pub. No.: US 2025/0124800 A1
(43) Pub. Date: Apr. 17, 2025

(54) METHOD FOR ASSISTING IN INSTALLATION OF WIRELESS SENSOR AND COMPUTING DEVICE

(71) Applicant: Aktiebolaget SKF, Göteborg (SE)

(72) Inventors: Xiaoyuan MA, Shanghai (CN); Hongwei WU, Shanghai (CN); Xing YI, Shanghai (CN); Xiaotao YUAN, Shanghai (CN); Liang ZHANG, Zou Cheng (CN)

(21) Appl. No.: 18/910,064

(22) Filed: Oct. 9, 2024

(30) Foreign Application Priority Data
Oct. 16, 2023 (CN) 202311337838.5

(51) Int. Cl. G09B 5/02

(52) U.S. Cl. CPC G09B 5/02

(57) ABSTRACT

A method for assisting in the installation of wireless sensors. The method is performed by a computing device and may include presenting, on a display interface of the computing device, a graphical element of the wireless sensor. An orientation of the graphical element in a displayed scene on the display interface is consistent with an installation orientation of the wireless sensor in an actual scene. The method may include presenting, on the display interface, an indication of an installation status of the wireless sensor. The installation status includes the installation orientation being correct or incorrect. The method may include presenting, on the display interface, a second indication of an adjustment suggestion for the installation orientation of the wireless sensor while the indication indicates that the installation orientation is incorrect. The adjustment suggestion includes an orientation adjustment direction and an orientation adjustment angle for the wireless sensor.

### CROSS-REFERENCE TO RELATED APPLICATION

This application claims priority to Chinese Application No. 202311337838.5, filed Oct. 16, 2023, the entirety of which is hereby incorporated by reference.

### FIELD

The present application relates to the field of sensor technology, and more particularly, to a method for assisting in installing a wireless sensor, a computing device, and a wireless sensor system including the wireless sensor and the computing device.

### BACKGROUND

A wireless sensor, which is a device that can collect sensory information and detect changes in local environment, is currently widely applied in various fields, such as the field of Internet of Things. Examples of wireless sensors include vibration sensors, proximity sensors, motion sensors, temperature sensors, and liquid sensors, among others. The wireless sensor may be installed close to some objects or not installed close to any objects depending on parameters that need to be sensed. As an example, a wireless vibration sensor, when in operation, typically needs to be installed close to a target object in order to detect vibration thereof. The data collected by the wireless sensor can be either transmitted wirelessly to a computing device in real time or stored in its built-in data storage (and can be read by the computing device), ensuring the accuracy of the collected data. In addition, the use of a built-in battery (e.g., a disposable battery or a rechargeable battery) to power the wireless vibration sensor can be employed.

Correct installation of the wireless sensor is a prerequisite for achieving effective perception. The installation orientation of the wireless sensor (installation orientation can also be equivalent to installation angles) is one of the most important parameters required for the measurement. Therefore, there is a need to check the accuracy of the installation orientation of the wireless sensor when it is being installed. However, it is difficult for the user to intuitively determine from the naked eye whether the installation orientation of the sensor is correct and how the installation orientation of the sensor should be adjusted, particularly in case of minor installation orientation deviations.

Therefore, there is a need for a solution that can indicate to the user whether the installation orientation of the sensor is correct to facilitate the installation of wireless sensors.

### SUMMARY

According to an aspect of the present application, there is provided a method for assisting in installation of a wireless sensor, performed by a computing device, comprising: presenting a graphical element of the wireless sensor on a display interface of the computing device, wherein an orientation of the graphical element in a displayed scene on the display interface is consistent with an installation orientation of the wireless sensor in an actual scene; presenting, on the display interface, an indication of an installation status of the wireless sensor, the installation status including the installation orientation being correct or the installation orientation being incorrect; and presenting, on the display interface, a second indication of an adjustment suggestion for the installation orientation of the wireless sensor while the indication indicates that the installation orientation is incorrect, the adjustment suggestion including an orientation adjustment direction and an orientation adjustment angle for the wireless sensor.

According to another aspect of the present application, there is further provided a computing device, comprising: a processor; and a memory having stored thereon a computer program which, when executed by the processor, causes the processor to perform operations as described above for installing a wireless sensor.

According to another aspect of the present application, there is also provided a wireless sensor system, comprising: one or more wireless sensors, each configured with an orientation detection assembly for detecting an installation orientation of a respective wireless sensor and including a wireless communication module; and a computing device as described above to assist in installing the one or more wireless sensors.

The wireless sensor according to the embodiments of the present application makes it possible for a user to easily interact with the wireless sensor through displaying information about the wireless sensor and its installation orientation on a display interface of a computing device, and the user can intuitively see the current installation status of the wireless sensor without introducing additional auxiliary devices even in the case where the installation deviation is small so that it cannot be directly observed by the naked eye. In addition, the user can also adjust the installation orientation of the wireless sensor based on the displayed indication of, for example, installation adjustment suggestions, thereby simplifying the installation process and guiding the user to achieve a more complex installation.

### BRIEF DESCRIPTION OF DRAWINGS

In order to more clearly illustrate the technical solutions in the embodiments of the present application or the prior art, the following will simply introduce the accompanying drawings which are needed in the description of the embodiments of the present application or the prior art, and it is obvious that the accompanying drawings in the following description are only some of the embodiments described in the present application, and other drawings can be obtained by those skilled in the art according to these drawings of the embodiments of the present application.

FIG. 1 shows a schematic diagram of an application scenario of a solution for assisting in installing a wireless sensor according to an embodiment of the present application.

FIGS. 2A-2C illustrate alternative interaction ways between a computing device and the wireless sensor according to an embodiment of the present application.

FIG. 3 illustrates a schematic flow diagram of a method for assisting in installation of the wireless sensor according to an embodiment of the present application.

FIG. 4 shows a schematic view of a graphical element of the wireless sensor presented on a display interface of the computing device.

FIG. 5 illustrates a schematic diagram of an interaction process flow of the wireless sensor with the computing device according to an embodiment of the present application.

FIG. 6 is a structural block diagram illustrating an apparatus for assisting in installation of the wireless sensor according to an embodiment of the present application.

### DETAILED DESCRIPTION

A clear and complete description will be made below of the technical solutions in the embodiments of the present disclosure in conjunction with the accompanying drawings in the embodiments of the present disclosure. Apparently, the described embodiments are only embodiments of a part of the present disclosure, rather than all of the embodiments. Based on the embodiments in the present disclosure, all other embodiments obtained by those of ordinary skill in the art without requiring inventive labor, belong to the scope of protection of the present disclosure.

As mentioned earlier, it is important to install the wireless sensor in the correct orientation, and often in a practical scenario, there may be one or more sensors. To date, to the Applicant's knowledge, it is very difficult for the user to directly determine from the naked eye whether the installation orientation of the sensor is correct and how it should be adjusted, in particular in case of minor installation orientation deviations. Field engineers who install the wireless sensor are required to check the installation orientation of the wireless sensor using traditional tools (e.g., a level is used for wireless sensors that need to be placed horizontally), and particularly for a multiple-sensor scenario, the installation orientation of each wireless sensor is manually checked one by one, and the accuracy of the check is largely dependent on the capabilities (e.g., attentiveness, experience, and responsibility) of the field engineer.

In order to enable the user to more intuitively see the installation orientation of each wireless sensor, in some embodiments of the present application, it may be considered that a display screen is provided at each wireless sensor so that the installation orientation detected by an orientation detection component (e.g., accelerometer) can be displayed on the screen. However, it is often impossible to equip a display screen at a wireless sensor due to limitations of its volume, cost, power consumption, and the like.

Accordingly, the embodiments of the present application contemplate utilizing a display screen at a computing device (e.g., a mobile terminal, a personal computer, digital personal assistant, etc.) to display a detected installation orientation of an orientation detection component (e.g., an accelerometer) of the wireless sensor. The wireless sensor is typically equipped with a wireless communication module (e.g. a wireless transceiver), so the computing device (also configured with the wireless communication module) can acquire orientation information associated with the detected installation orientation from the wireless sensor over the wireless communication link and visually display the installation orientation on its display screen.

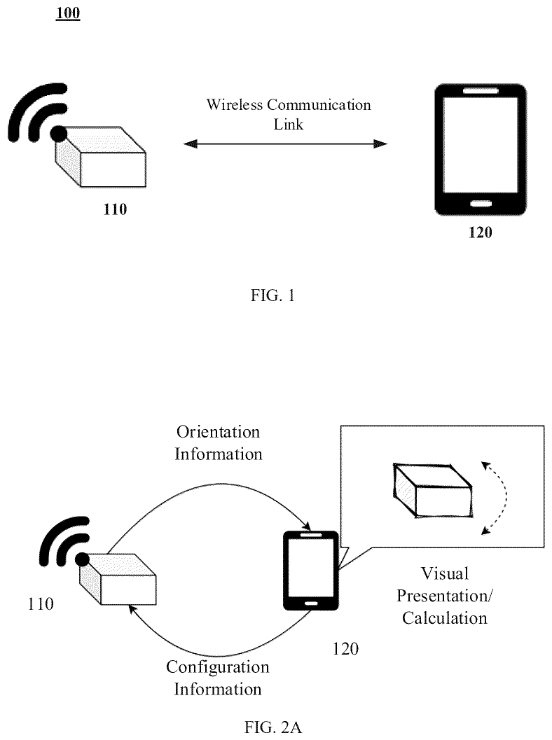

FIG. 1 shows a schematic diagram of an application scenario of the solution according to an embodiment of this application. The application scenario includes a system consisting of a wireless sensor and a computing device.

The system 100 includes a wireless sensor 110 and a computing device 120 that can communicate or interact via a wireless communication link. Typically, an orientation detection component (e.g., one or more of an accelerometer, a gyroscope, and/or a magnetometer, etc.) may be provided at the wireless sensor 110 for detecting a current installation orientation of the wireless sensor, i.e., the wireless sensor may detect its current installation orientation (current orientation) (e.g., the orientation may correspond to an angle, which may include one or more of a pitch angle, a roll angle, a yaw angle). Different orientation detection components correspond to different orientation detection modes, so that the representation of the current orientation at the wireless sensor may be different. For example, when the orientation detection component comprises a three-axis accelerometer, the orientation detected by the orientation detection component at the wireless sensor may be represented by acceleration component values in three axes (mutually perpendicular (orthogonal) X-axis, Y-axis, and Z-axis, the direction perpendicular to the ground being taken as the Y-axis), which after calculation may result in respective angular values (the calculation may be performed at the wireless sensor or at a computing device). Of course, when other types of orientation detection components are employed, it is also possible that various angular values are detected and determined directly at the wireless sensor and then transmitted as orientation information to the computing device for the computing device to use directly. The wireless sensor 110 can then transmit orientation information associated with the detected current installation orientation to the computing device 120, which can determine (e.g., calculate) various angular values corresponding to the installation orientation based on the orientation information. Typically, an application or client or the like associated with the wireless sensor may be installed at the computing device 120 (e.g., obtained from a server of a vendor of the wireless sensor or other server), to display information such as an installation orientation of the wireless sensor on the display interface of the application or client on the display screen of the computing device as will be described later. Before the wireless sensor 110 transmits specific orientation information to the computing device 120, a communication link can be established between the wireless communication module of the wireless sensor and the computing device 120 and enable authentication and/or authorization of the wireless sensor at the computing device, among other operations.

The computing device 120, upon receiving the orientation information transmitted from the wireless sensor 110, and determining the installation orientation based on the orientation information, and then performing a display process according to the installation orientation, can display a graphical element of the wireless sensor on its display interface, as described below.

Optionally, the computing device 120 and the wireless sensor 110 can communicate through a direct wireless communication link and an indirect wireless communication link.

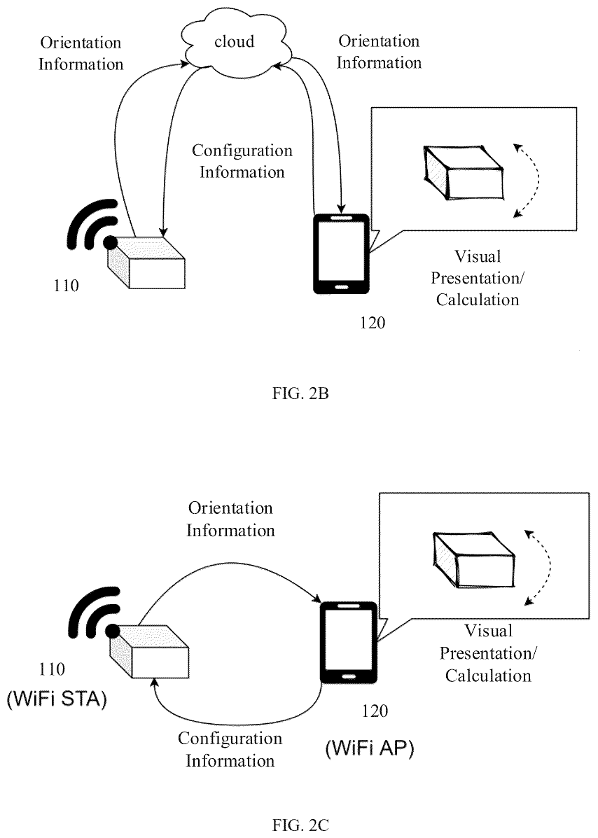

For example, FIGS. 2A-2C illustrate alternative interaction ways between the computing device 120 and the wireless sensor 110.

As shown in FIG. 2A, the computing device 120 and the wireless sensor 110 are shown communicating over a low latency wireless communication (e.g., Bluetooth Low Energy technology) link.

The wireless sensor 110 transmits a data stream including orientation information to the computing device 120 via the low latency wireless communication, which is received by the computing device 120, and then the computing device 120 parses and computes the orientation information to obtain the installation orientation of the wireless sensor. In addition, the computing device 120 can also optionally return configuration information for the wireless sensor (e.g., information unknown to the wireless sensor itself, such as the type or size, etc., of a perceived object such as the wireless sensor) to the wireless sensor based on this low latency wireless communication.

As another example, when the low latency wireless communication is not available, the computing device 120 may communicate with the wireless sensor 110 via cloud if both the wireless sensor 110 and the computing device 120 have access to the cloud. Alternatively, the wireless sensor 110 can access the cloud by communicating with the cloud using wireless fidelity (WiFi) functionality or a cellular network, as shown in FIG. 2B.

Alternatively still, when the low latency wireless communication is not available, if the wireless sensor is also equipped with a WiFi functionality, and the computing device 120 is capable of operating as a WiFi access point (WiFi AP), then the wireless sensor 110 can operate as a WiFi station (WiFi STA), communicating with the computing device 120, as shown in FIG. 2C. In this manner, the latency at the computing device 120 to acquire the orientation information of the wireless sensor 110 (i.e., the latency of communications in the direction from the wireless sensor 110 to the computing device 120) can be shortened.

As mentioned earlier, correct installation of the wireless sensor is a prerequisite for achieving effective perception, and therefore the installation orientation of the wireless sensor needs to be accurately identified and presented to the user, in particular for the minor installation orientation deviations. Based on the schematic diagram of the application scenario shown in FIG. 1, the following introduces a solution for assisting in installation of the wireless sensor according to an embodiment of the present application.

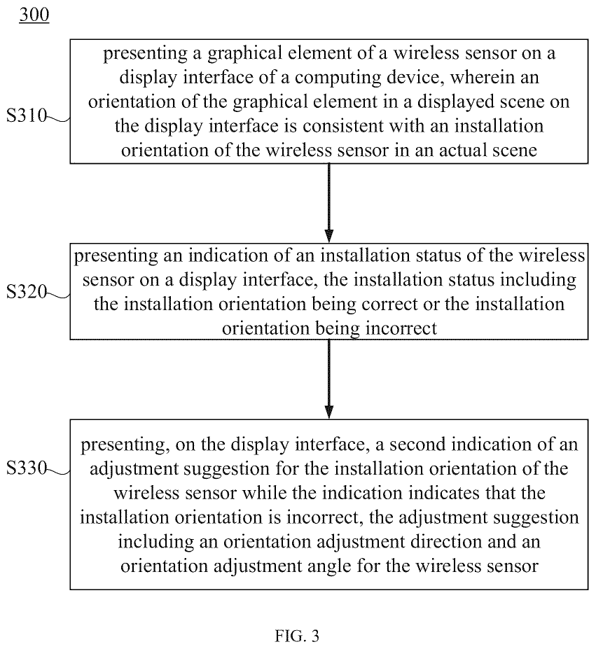

FIG. 3 illustrates a method for assisting in installation of a wireless sensor according to an embodiment of the present application. The method may be performed by the computing device 120 shown in FIG. 1.

As shown in FIG. 3, in step S310, a graphical element of a wireless sensor is presented on a display interface of a computing device, where an orientation of the graphical element in a displayed scene on the display interface is consistent with an installation orientation of the wireless sensor in an actual scene.

For example, as previously described, the wireless sensor can detect its current installation orientation through the orientation detection component (e.g., an accelerometer), and the computing device can obtain a data stream including orientation information of the wireless sensor from the wireless sensor through a direct wireless communication link (e.g., Bluetooth or a network that the wireless sensor accesses with the computing device as an access point, AP) or an indirect wireless communication link (e.g., via a cloud service). The computing device can then parse and compute the acquired data stream to determine the installation orientation of the wireless sensor.

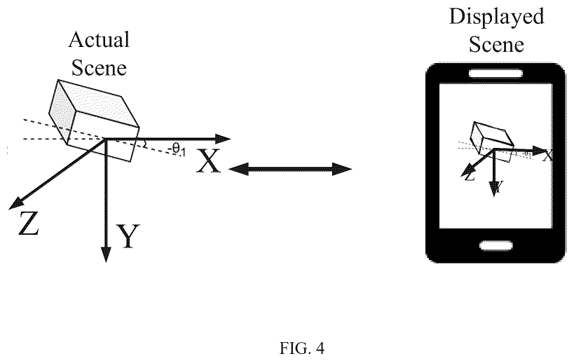

An application or client corresponding to the wireless sensor is installed at the computing device, and after the installation orientation of the wireless sensor is obtained, the graphical element of the wireless sensor is rendered on the display interface of the application or client (collectively referred to as a display interface of the computing device) through a display process (e.g., graphical rendering, graphical element generation, etc.). For example, the computing device, while acquiring the data stream including the orientation information from the wireless sensor, also acquires identification information of the wireless sensor, so that the computing device can query (e.g., in a local database or an Internet database, etc.) specification parameter information (e.g., machine type, component size, model, and/or manufacturer, etc.) of the wireless sensor based on the identification information, and then generate a graph element of the wireless sensor based on the specification parameter information. Alternatively, the identification information of the wireless sensor and the information required for the generation of the graph element have been stored in association in advance, so that the required information can be queried directly based on the identification information, to generate a graphical element of the wireless sensor based on the required information for display on the display interface. At the same time, the computing device may also display the orientation of the graphical element in the displayed scene on the display interface consistently with the installation orientation of the wireless sensor according to the obtained installation orientation, so that the user can know the current specific installation orientation of the wireless sensor through the display interface of the computing device. In this application, the orientation referred to may include pitch, roll, yaw angles, or even direction (e.g., magnetic field direction), and the information used to determine the various angles (i.e., orientation information) may be obtained using an orientation detection component (e.g., a three-axis accelerometer). As shown in FIG. 4, which shows a schematic view of a graphical element of a wireless sensor presented on a display interface of a computing device, where the X-axis, the Y-axis, and the Z-axis are mutually perpendicular (or orthogonal), it can be seen from FIG. 4 that the orientation of the graphical element in the displayed scene is consistent with the installation orientation of the wireless sensor in the actual scene. Optionally, the determined (e.g., calculated) specific numerical angular value of the installation orientation of the wireless sensor may also be presented on the display interface.

In step S320, an indication of an installation status of the wireless sensor is presented on the display interface, the installation status including the installation orientation being correct or the installation orientation being incorrect.

For example, the computing device may compare the obtained installation orientation to a reference installation orientation of the wireless sensor and determine whether the installation orientation of the wireless sensor is correct based on the comparison. For example, when the difference of the installation orientation from the reference installation orientation is within a threshold range (e.g., at or near 0°), the installation orientation is determined to be correct, and an indication is generated for indicating that the installation orientation is correct. For example, when the installation orientation is expressed as a pitch angle, a roll angle, and a yaw angle, the installation orientation needs to be determined to be correct when each of the three angles, respectively, differs from a corresponding reference angle within a threshold range. Alternatively, depending on the actual needs, in other implementations, only one or two of the three angles may be compared with the corresponding reference angle(s). In other embodiments, the installation orientation may be represented by different types of angles, so that the type and number of reference angles may be of different types accordingly. Further, when the acquired installation orientation of the wireless sensor differs from the reference installation orientation beyond the threshold range, the indication for indicating that the installation orientation is incorrect is determined and generated.

Optionally, the reference installation orientation is pre-set, e.g. the user pre-sets the reference installation orientation according to the application scenario of the wireless sensor. For example, the user may be prompted to input various angular values of the reference installation orientation through the display interface of the application or client installed on the computing device e.g. after start-up, before the graphical element of the wireless sensor is displayed.

In addition, the reference installation orientation may also be determined by the computing device based on the type of the wireless sensor. For example, after the wireless sensor establishes the communication link with the computing device, the wireless sensor may first transmit its identification information to the computing device, the computing device may determine the type of the wireless sensor (e.g., a vibration sensor, a proximity sensor, or a temperature sensor, etc.) based on the identification information and thereby determine the reference installation orientation according to the type. For example, if it is the wireless vibration sensor which needs to be placed in a horizontal plane to better reduce the interference of gravity with the vibration detection effect to achieve a more accurate detection effect, the reference installation orientation is thus set based on respective theoretical values of the pitch, roll and yaw angles when the wireless vibration sensor is placed in a horizontal plane, e.g. the pitch angle is 0° and the roll angle is 0°, and the yaw angle may not be set, i.e. only the pitch and roll angles derived from the acquired orientation information need to be compared with the pitch and roll angles of the reference installation orientation (0°).

Further, the reference installation orientation may also be determined by the above-described computing device analyzing based on the scene to which the wireless sensor is applied, e.g., when the orientation of the wireless sensor is associated with an orientation of the target object (the object that the wireless sensor is to sense). At this time, the method shown in FIG. 3 may further comprise the steps of: acquiring a scene image of a scene to which the wireless sensor is applied; identifying, from the scene image, an orientation in the scene image of an object to be targeted by the wireless sensor, and based on the orientation of the object, determining the reference installation orientation of the wireless sensor. For example, the computing device itself may be configured with an image capturing device (e.g., a camera) for capturing the scene image of current application scene or acquiring the captured scene image from an external image capturing device (e.g., a camera), and utilizing image processing techniques (e.g., image pre-processing, filtering, or rotating, etc.) and image recognition techniques (e.g., classification and detection algorithms in object recognition, etc.), etc. to identify the orientation of the target object in the scene so as to determine the reference installation orientation of the wireless sensor based on association between the wireless sensor and the target object.

In step S330, while the indication indicates that the installation orientation is incorrect, a second indication of an adjustment suggestion for the installation orientation of the wireless sensor is presented on the display interface, the adjustment suggestion including an orientation adjustment direction and an orientation adjustment angle for the wireless sensor.

For example, when the difference between the installation orientation of the wireless sensor and the reference installation orientation exceeds the threshold range, the orientation adjustment direction and the orientation adjustment angle in the second indication may be determined based on the difference between the installation orientation and the reference installation orientation, and the second indication may be generated. For example, the orientation adjustment angle is an angular difference of at least one of the aforementioned three-axis angular values from a respective reference angular value, and the orientation adjustment direction is determined based on a positive or negative value of the angular difference.

Alternatively, the installation process of the wireless sensor may involve multiple adjustment procedures, and thus, the wireless sensor transmits an updated installation orientation to the computing device regularly or in response to a triggering event from the computing device, the updated installation orientation being the adjusted installation orientation of the wireless sensor. The computing device may, in response to the installation orientation of the wireless sensor being adjusted, present an updated graphical element of the wireless sensor on the display interface of the computing device upon receipt of the updated orientation information (associated with the adjusted or updated installation orientation), where an orientation of the updated graphical element in the displayed scene on the display interface is consistent with the adjusted installation orientation of the wireless sensor. After one or more such adjustment procedures, eventually the wireless sensor will be adjusted to an installation orientation that is substantially consistent with the reference installation orientation (i.e., the difference between the installation orientation and the reference installation orientation is within the threshold range).

In some embodiments, a plurality of wireless sensors may be installed in a practical application scenario such that each wireless sensor may establish a communication link with the computing device to communicate and interact therewith. Graphical elements of the plurality of wireless sensors (with corresponding orientations) and respective indications (as described above) can be displayed on the display interface of the computing device. The computing device can perform the above-described method of assisting in installation for each wireless sensor independently.

Optionally, the computing device can also provide an interaction option on the display interface so that the user can view all of the wireless sensors or a portion of the wireless sensors (e.g., of higher priority) through interaction with this interaction option, in the event that all of the required displayed wireless sensors cannot be displayed on one display interface. For example, the interaction option is presented on current display interface and, in response to the user interacting (e.g., touching or clicking) with the interaction option, different display interfaces are switched to be displayed, so that the graphical elements of all the desired displayed wireless sensors are displayed on the different display interfaces that are switchable, in this case, the interaction option may be a switch option and the graphical elements of some of the wireless sensors are displayed on each display interface so that the user can view information about the installation orientation of all the wireless sensors on the respective display interfaces that are switchable. Alternatively, in response to user interaction with the interaction option, the identification information (e.g., in the form of a drop-down list) of all of the wireless sensors (each of which has established a wireless communication link with the computing device) is presented, and in response to a user selection operation for the identification information of one or more wireless sensors in the list, the graphical elements of the one or more wireless sensors are displayed on that display interface or on a different display interface that is switchable. Also, the graphical elements of the selected one or more wireless sensors may not all be presented on one display interface, so the switch option may also be displayed on each display interface accordingly). Of course, alternatively or additionally, an input box may also be provided directly on the display interface for the user to enter identification information of the one or more wireless sensors whose graphical elements are to be displayed.

By visually presenting the wireless sensor and its installation orientation related information on the display interface of the computing device, the user can easily interact with the wireless sensor, the current installation status of the wireless sensor can be intuitively seen without introducing additional auxiliary devices, even in cases where the installation deviation is small to be directly observable by the naked eye. In addition, the user may also adjust the installation orientation of the wireless sensor according to the displayed indication of, for example, an installation adjustment suggestion. In the case of a plurality of wireless sensors, the indication of the installation adjustment suggestion for each of the plurality of wireless sensors may also be displayed, thereby simplifying the installation process, and may also guide the user to achieve a more complex installation, for example, in the scenario of a calibration installation where the installation of a certain wireless sensor requires a plurality of installation procedures, each of which may be assisted by the proposed method.

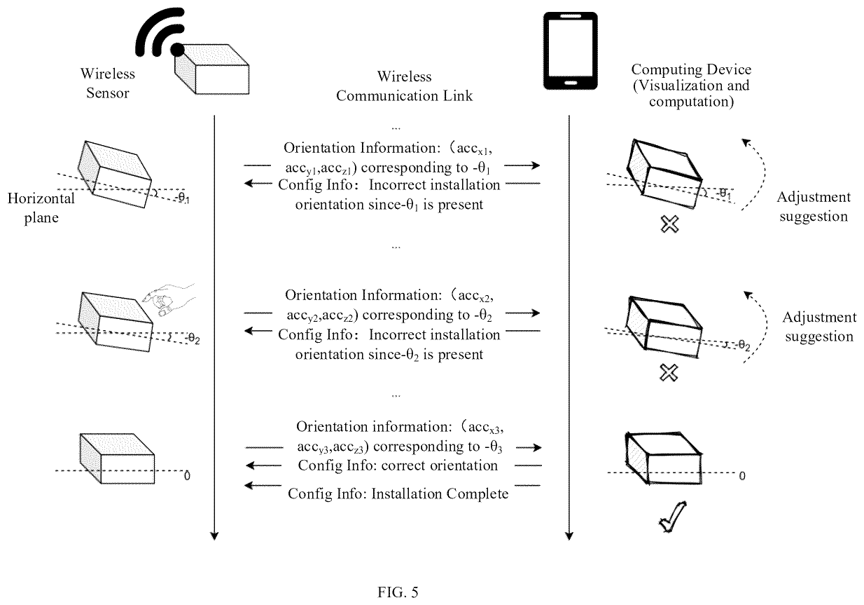

FIG. 5 schematically illustrates a schematic diagram of an interaction process flow of the wireless sensor with the computing device, according to an embodiment of the present application. In the example of FIG. 5, one wireless sensor is illustrated, and the installation orientation and the reference installation orientation are represented by one angle (e.g., the roll angle).

As shown in FIG. 5, firstly, the wireless sensor in the physical environment of the actual scene transmits relevant information of an installation orientation (collectively orientation information) to the computing device (e.g., a mobile terminal) over a wireless communication link. The wireless sensor can transmit measurement parameters (the orientation information) measured with the accelerometer for deriving the installation orientation (e.g., respective acceleration component values accₓ₁,acc_{y1},acc_{z1} on the X-axis, Y-axis, and Z-axis corresponding to the installation orientation (e.g., roll angle −θ₁)) to the computing device. The computing device can derive the installation orientation of the wireless sensor based on the obtained orientation information and correspondingly display the graphical element of the wireless sensor and the corresponding installation orientation on its display interface. At this time, since the reference installation orientation of the wireless sensor should be an orientation corresponding to horizontal placement (e.g., a roll angle of 0°), the indication that the current installation orientation is incorrect and the second indication that the current installation orientation is deviated from the reference installation orientation by −θ₁, and the wireless sensor should be adjusted upward are displayed on the display interface of the computing device. Optionally, the computing device can also return the indication to the wireless sensor that the installation orientation of the wireless sensor is incorrect. In the present application, the computing device may also return configuration information to the wireless sensor (e.g., by which specification parameter information of the queried wireless sensor is retrieved from the database based on the identification information of the wireless sensor).

The user may then adjust the installation orientation of the wireless sensor in the real physical environment according to the displayed content on the display interface of the computing device, and the wireless sensor may then transmit the updated measurement parameters (e.g., respective acceleration component values accₓ₂,acc_{y2},acc_{z2} in the X-axis, Y-axis, and Z-axis corresponding to the adjusted installation orientation (e.g., angle −θ₂) measured with the accelerometer to the computing device for deriving the updated installation orientation. The computing device may derive the updated installation orientation of the wireless sensor based on the obtained orientation information, and correspondingly display the graphical element of the wireless sensor and the corresponding updated installation orientation on its display interface. At this point, the adjustment may not have been completed once, and thus the indication that the current installation orientation is incorrect and the second indication that the current installation orientation is deviated from the reference installation orientation by −θ₂, and the wireless sensor should continue to be adjusted upward may also be displayed on the display interface of the computing device. Optionally, the computing device can also return the indication to the wireless sensor that the installation orientation of the wireless sensor is incorrect.

The user can then continue to adjust the installation orientation of the wireless sensor in the real physical environment according to the content displayed on the display interface of the computing device, and the wireless sensor can then transmit the updated measurement parameters (e.g., respective acceleration component values accₓ₃,acc_{y3},acc_{z3} in the X-axis, Y-axis, and Z-axis corresponding to the adjusted installation orientation) to the computing device. The computing device can derive the updated installation orientation of the wireless sensor based on the obtained orientation information, and correspondingly display the graphical element of the wireless sensor and the corresponding updated installation orientation on its display interface. At this point, the installation orientation of the wireless sensor has been correct, so the computing device, based on the updated orientation information, may calculate that the current installation orientation differs from the reference installation orientation by 0 (or within a threshold range), so that the indication that the current installation orientation is correct and, optionally, the second indication that indicates an angle of 0° from the reference installation orientation are displayed on the display interface of the computing device. Optionally, the computing device can also return the indication that the installation orientation of the wireless sensor is correct to the wireless sensor.

As can be seen, with the assistance of the computing device, the user can appropriately determine the adjustment magnitude as well as the direction according to the prompt information on the display interface on the computing device during the adjustment of the wireless sensor, so that the wireless sensor can be installed more efficiently and accurately, which is more pronounced in the actual application scenario where there are a plurality of wireless sensors.

Accordingly, according to another aspect of the present application, there is also provided an apparatus for assisting in installation of a wireless sensor.

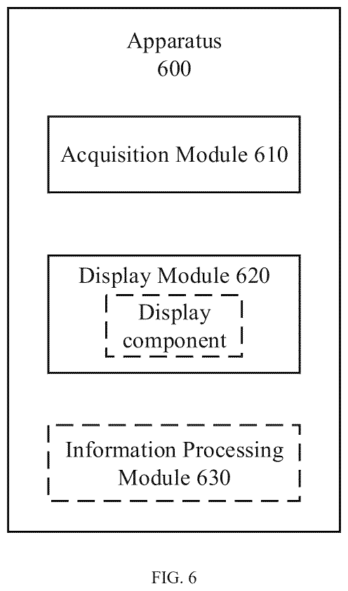

FIG. 6 is a structural block diagram illustrating an apparatus for assisting in installation of a wireless sensor according to an embodiment of the present application. The apparatus may be or be included in the computing device as shown in FIG. 1.

The apparatus 600 may include an acquisition module 610 and a display module 620, where the display module 620 includes a display component (e.g., a display screen) for presenting a display interface or the display module 620 is associated with a display interface at the display component separate from the display module.

The acquisition module 610 may be configured to obtain orientation information from a wireless sensor via a direct wireless communication link or via a cloud service, the orientation information being associated with an installation orientation of the wireless sensor. The display module 620 may be configured to: present, on the display interface of the computing device, a graphical element of the wireless sensor, where an orientation of the graphical element in a displayed scene on the display interface is consistent with the installation orientation of the wireless sensor in an actual scene; present, on the display interface, an indication of an installation status of the wireless sensor, the installation status including the installation orientation being correct or the installation orientation being incorrect; and present, on the display interface, a second indication of an adjustment suggestion for the installation orientation of the wireless sensor while the indication indicates that the installation orientation is incorrect, the adjustment suggestion including an orientation adjustment direction and an orientation adjustment angle for the wireless sensor.

Optionally, the apparatus may further include an information processing module 630 that may be configured to derive the installation orientation of the wireless sensor based on the orientation information obtained from the wireless sensor, and compare the installation orientation with a reference installation orientation to determine the installation status of the wireless sensor, and provide the installation status to the display module to cause the display module to generate and display corresponding indication on the display interface.

The individual modules of the apparatus may be divided in different ways, or may be further divided into more sub-modules. Each module or sub-module may be implemented in a special-purpose hardware-based system (e.g., a general-purpose processor, a digital signal processor (DSP), an application specific integrated circuit (ASIC), an off-the-shelf programmable gate array (FPGA) or other programmable logic device, discrete gate or transistor logic, discrete hardware components) that performs a specified function or operation, or may be implemented in a combination of special-purpose hardware and computer instructions. More details of the respective modules can be referred to the foregoing detailed description, which will not be repeated here.

Accordingly, according to another aspect of the present disclosure, there is also provided a wireless sensor system. The system may be the system shown in FIG. 1 and may include: one or more wireless sensors, each configured with an orientation detection component for detecting an installation orientation of the wireless sensor and including a wireless communication module; a computing device as previously described for assisting in installation of the one or more wireless sensors.

Optionally, the system may further include the cloud, the one or more wireless sensors and the computing device being accessible to the cloud such that the one or more wireless sensors and the computing device can communicate with each other via the cloud service provided by the cloud when the one or more wireless sensors and the computing device are unable to communicate directly.

By way of example, a computing device of the present application may include a processor, memory connected through a system bus, and may further include a network interface, an input means, and a display screen, among others. Wherein the memory comprises a non-volatile storage medium and an internal memory. The non-volatile storage medium of the computer device stores an operating system and may also store a computer-executable program that, when executed by the processor, causes the processor to perform various operations as previously described with respect to the computing device. The internal memory may also have stored therein a computer-executable program that, when executed by the processor, causes the processor to perform various operations as previously described with respect to the computing device.

The processor may be an integrated circuit chip having signal processing capabilities. The processor described above may be a general purpose processor, a digital signal processor (DSP), an application specific integrated circuit (ASIC), an off-the-shelf programmable gate array (FPGA) or other programmable logic device, discrete gate or transistor logic, discrete hardware components for implementing or performing the disclosed methods, steps and logical block diagrams in the embodiments of the present application. The general-purpose processor may be a microprocessor or the processor may be any conventional processor or the like and may be of an X84 architecture or an ARM architecture.

The non-volatile memory may be a read-only memory (ROM), a programmable read-only memory (PROM), an erasable programmable read-only memory (EPROM), an electrically erasable programmable read-only memory (EEPROM), or a flash memory. It should be noted that the memory described herein is intended to comprise, without being limited to, these and any other suitable classes of memories.

The display screen may be a liquid crystal display screen or an electronic ink display screen, and the input means of the computer device may be a touch layer overlaid on the display screen, a button, a trackball or a trackpad provided on the housing of the terminal, or may be an external keyboard, trackpad or mouse, or the like.

It is noted that the flowchart and block diagrams in the Figures illustrate the architecture, functionality, and operation of possible implementations of methods and apparatus according to various embodiments of the present application. In this regard, each block in the flowchart or block diagrams may represent a module, segment, or a portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, or individual modules mentioned, can be implemented by special purpose hardware-based systems that perform the specified functions or operations, or combinations of special purpose hardware and computer instructions.

The embodiments of the present application as described in detail above are merely illustrative, but not limiting. It should be understood by those skilled in the art that various modifications and combinations of these embodiments or features thereof may be made without departing from the principles and spirit of the present application, such modifications shall fall within the scope of the present application.

What is claimed is:

1. A method, performed by a computing device, for assisting in installation of a wireless sensor, comprising:
presenting a graphical element of the wireless sensor on a display interface of the computing device, wherein an orientation of the graphical element in a displayed scene on the display interface is consistent with an installation orientation of the wireless sensor in an actual scene;
presenting, on the display interface, an indication of an installation status of the wireless sensor, the installation status including the installation orientation being correct or the installation orientation being incorrect; and
presenting, on the display interface, a second indication of an adjustment suggestion for the installation orientation of the wireless sensor while the indication indicates that the installation orientation is incorrect, the adjustment suggestion including an orientation adjustment direction and an orientation adjustment angle for the wireless sensor.

2. The method of claim 1, further comprising:
acquiring orientation information from the wireless sensor and determining the installation orientation of the wireless sensor based on the orientation information; and
comparing the installation orientation of the wireless sensor with a reference installation orientation of the wireless sensor and generating the indication and/or the second indication based on a comparison result,
wherein the reference installation orientation is preset or determined by the computing device based on a type of the wireless sensor or based on an analysis of a scene image of a scene to which the wireless sensor is applied.

3. The method of claim 2, further comprising:
acquiring the scene image of the scene to which the wireless sensor is applied;
identify, from the scene image, an orientation in the scene image of an object to be targeted by the wireless sensor; and
determining the reference installation orientation of the wireless sensor based on the orientation of the object targeted by the wireless sensor.

4. The method of claim 2, wherein generating the indication and/or the second indication based on the comparison result comprises:
determining that the installation orientation is correct and generating the indication in response to the difference of the installation orientation from the reference installation orientation being within a threshold range; and/or
determining that the installation orientation is incorrect and generating the indication in response to the difference of the installation orientation from the reference installation orientation being outside the threshold range, and determining the orientation adjustment direction and the orientation adjustment angle based on the difference of the installation orientation from the reference installation orientation and generating the second indication.

5. The method of claim 1, further comprising:
acquiring identification information of the wireless sensor from the wireless sensor; and
querying for specification parameter information of the wireless sensor or for information required for generating the graphic element of the wireless sensor based on the identification information;
wherein presenting, on the display interface of the computing device, the graphical element of the wireless sensor comprises:
generating and presenting the graphical element of the wireless sensor based on the specification parameter information or based on the information required for generating the graphical element of the wireless sensor, and setting, according to the installation orientation, the orientation of the graphical element in the displayed scene on the display interface to be consistent with the installation orientation.

6. The method of claim 1, wherein
the computing device communicates with the wireless sensor via a direct wireless communication link, or,
the computing device communicates with the wireless sensor via a cloud service.

7. The method of claim 1, further comprising:
presenting an updated graphical element of the wireless sensor on the display interface of the computing device, in response to the installation orientation of the wireless sensor being adjusted, wherein an orientation of the updated graphical element in the displayed scene on the display interface is consistent with the adjusted installation orientation of the wireless sensor.

8. The method of claim 1, wherein there are a plurality of wireless sensors, and the method further comprises:
presenting an interaction option on the display interface, and
switching between different display interfaces, in response to user interaction with the interaction option, to display graphical elements of all wireless sensors on switchable different display interfaces, or
presenting identification information of the plurality of wireless sensors in response to user interaction with the interaction option, and displaying graphic elements of one or more wireless sensors among the plurality of wireless sensors on the display interface or a switchable different display interface, in response to user selection or input operation with respect to identification information of the one or more wireless sensors.

9. A computing device comprising:
a processor; and
a memory having stored thereon a computer program which, when executed by the processor, causes the processor to perform the operations of claim 1 for installing a wireless sensor.

10. A wireless sensor system comprising:
one or more wireless sensors, each wireless sensor configured with an orientation detection component for detecting an installation orientation of the wireless sensor and including a wireless communication module; and
the computing device of claim 9 to assist in installation of the one or more wireless sensors.

11. A computing device comprising:
a processor; and
a memory having stored thereon a computer program which, when executed by the processor, causes the processor to perform the operations of claim 4 for installing a wireless sensor.

12. A wireless sensor system comprising:
one or more wireless sensors, each wireless sensor configured with an orientation detection component for detecting an installation orientation of the wireless sensor and including a wireless communication module; and
the computing device of claim 11 to assist in installation of the one or more wireless sensors.
